(19) United States
(12) Patent Application Publication
(10) Pub. No.: US 2006/0046850 A1
(43) Pub. Date: Mar. 2, 2006

(54) Sound control game player

(76) Inventor: Cho-Ki Chow, Surrey (CA)

Correspondence Address: CHO-KI CHOW, 16585 108th Ave, Surrey, BC, V4N 1N6, CA

(21) Appl. No.: 10/930,035

(22) Filed: Aug. 31, 2004

(51) Int. Cl. G06F 17/00; G06F 19/00

(52) U.S. Cl. 463/41

(57) ABSTRACT

I, Cho-Ki Chow, have invented a Sound Control Game Player, as set forth in the following specification. The claimed system is used by two or more people of all age groups to play a game without the Internet access. The invention is composed of a sound identification system, which enables the players to communicate and play the game through telephone lines. The system is based on the crystal chip memory, which can store and transmit sound and pictures to users' LCD screen when oral instructions are given. Thus the two or more people may play the game as if they are sitting face to face.

### BACKGROUND OF THE INVENTION

Most games on today's market are mainly developed for children. Whether games are played online or through networks, they are all on a one-to-one basis. This may be attractive to children or young adults, but not to mature adults. To address this issue and make games appealing to all age groups, I invented an intelligent-based sound control game player, which enables you to play games with your selected partners through telephone line.

### BRIEF SUMMARY OF THE INVENTION

The Sound Control Game Player I invented is based on an entirely new concept. It enables two or more people to play real games through telephone networks. The game player is integrated with crystal chip memory, which can store and transmit sound and pictures. When the power switch button is pressed, a game network is connected by dialling number on the dial pad of the device. One can speak out what kind of game to play to his or her partner. Then the invitation is sent out through the sound identification system and the telephone line. The response of the partner is sent back in the same way. The central inductive control unit processes the information and retrieves other relative information from memory A and B, and then sends output signals to LCD screen and sound effective system. Thus the two or more people can play the game as if they are sitting face to face.

### BRIEF DESCRIPTION OF THE DRAWINGS

FIG. 1 shows a flowchart of sound control game box (hereinafter called the system).

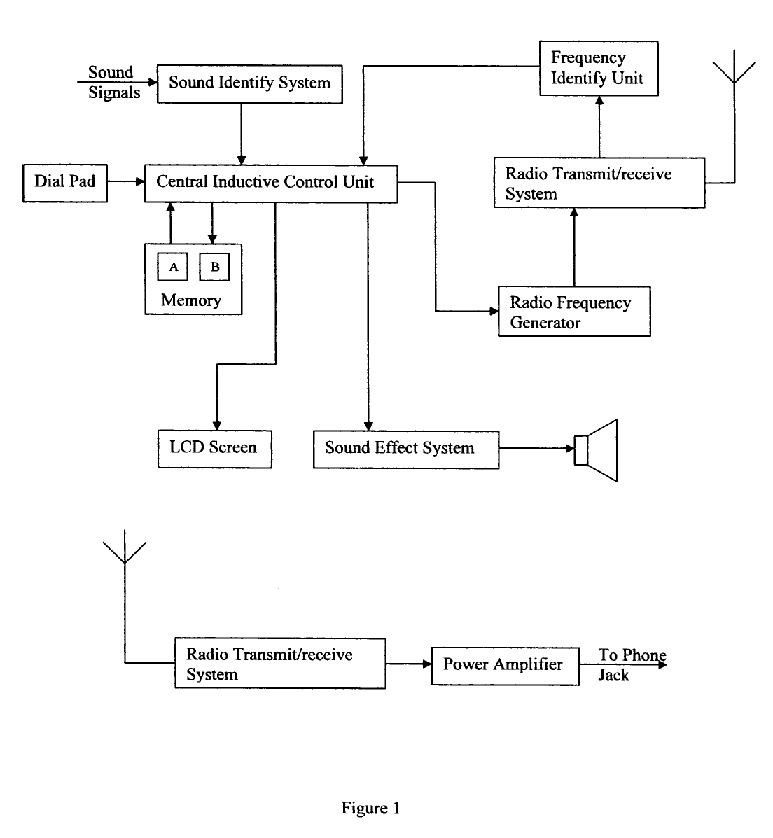

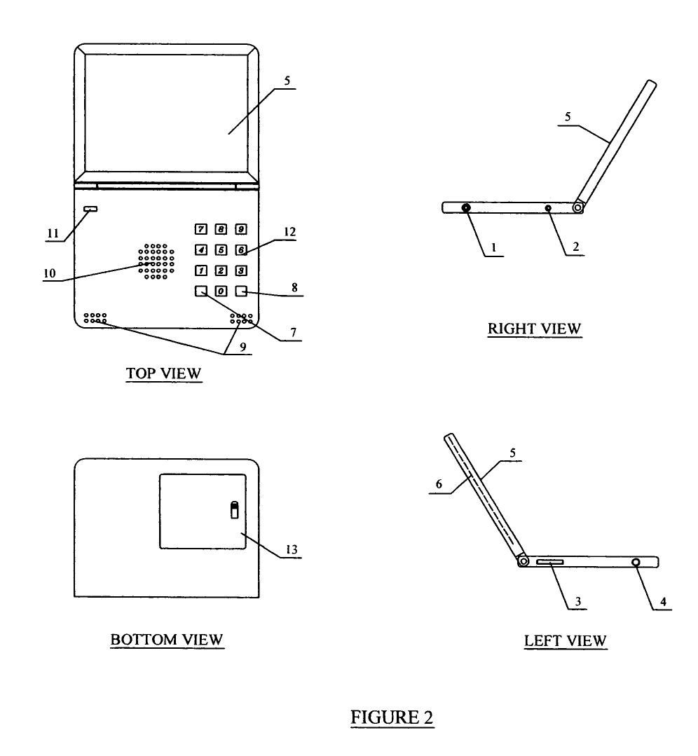

FIG. 2 shows views of the system. Names or functions of the numbered items are listed below:
1. Power switch button
2. DC input jack
3. Memory slot
4. Earphone jack
5. LCD screen
6. Hidden antenna
7. Signal sending indicator (green light).

### DETAILED DESCRIPTION OF THE INVENTION

The sound control game player is based on the crystal chip memory, which can store and transmit sound and pictures. The invention is composed of central inductive control unit, radio transmit-receive system including radio frequency identifier and frequency power amplifier, sound effect system and memory A and B. Memory A stores the segment of the match as well as the movements of the ball, whereas memory B stores the full movements and image of the players as well as 10 motions of every player, the movements of the ball and the changes in the match. The player's special action such as blocking the ball can be displayed with sound identification system when you speak it out. When the memory card is put into the sound control game player to receive induction effect from the central inductive control unit, the light of the game player is turned on, indicating that all movements and actions are started. In the meanwhile, the central inductive control unit transmits and displays the data stored in memory A to LCD screen. Memory A contains special serial number and radio frequency signal, such as 001 for hockey, 002 for basketball, 003 for football, and 004 for volleyball. Different items such as competition films have their own serial number and radio frequency, which are transmitted and received through telephone networks. A particular radio frequency signal can only be received by the operating game player with the same serial number on. For instance, the game player with radio frequency 001 serial number turned on will not be able to receive signals from the game players with radio frequency 002 or 003 serial number on.

When the home phone number plus access code is entered, the sound control game player sends out a particular radio frequency signal through telephone networks, searching for a partner with the same serial number. When the partner participates in the match, he or she can select the player with a particular serial number through the sound identification system. The participator's initial voice is set up as base phoneme to prevent other's voice from interfering with the game. In the operation of the game player, the base phoneme remains valid for five minutes. Within five minutes, the second oral instruction must be given, or the base phoneme will be void and give way to the new phoneme.

The sound identification system can interpret and transmit the meaning of English and Chinese spoken words to the central inductive control unit. According to the oral instruction, memory B provides a particular player's movements. The central inductive control unit then transmits the new information to LCD screen. Through the connection of the telephone networks, the participator's game player will display the information on its screen. The participator can see the entire induction process, experience the stimulation of the induction, and respond accordingly by giving the best instruction. The result of the induction process of sound and pictures are strengthened by the functioning of the sound effect system integrated in the device.

When the power switch button 1 is pressed, a game network is connected by dialling the number on dial pad 12. When you speak out what kind of game you want to play, an invitation is sent out through the sound identification system. The information is first transferred to central inductive control unit, and then to the power amplifier through radio frequency generator and radio transmit-receive system. The power amplifier receives the signals and sends the signals out to your partner through telephone lines. The responsive signals are received by power amplifier and sent to radio transmit-receive system and then transferred to the central inductive control unit through frequency identification unit. The central inductive control unit processes the information and retrieves other relative information from memory A and B, and then send output signals to LCD screen and sound effective system.

What I claim as my invention is:

1) The integration and induction technology of prerecorded and stored real ball game players' competition actions and special movements accompanied by simultaneous sound prompt and control.

2) Code system with special frequency is used to distinguish different matches such as hockey, basketball, football, volleyball and other different items such as competition films. The processing technology of recording and storing the above data in Memory A.

3) The processing technology of starting the power amplifier of the telephone networks and radio transmit-receive system by dialing home phone number plus personal access code to search for the same game players.

4) The processing technology of sound identification system based on the first standard phoneme, including the processing technology that can identify phonetic meaning.

5) The process of independent design and induction of mutual and multi-control competition without the Internet access.
